(19) United States
(12) Patent Application Publication
(10) Pub. No.: US 2024/0149266 A1
(43) Pub. Date: May 9, 2024

(54) METHOD AND APPARATUS FOR DETECTING CHANGES IN FLUID COMPOSITION AND FLOW IN A CHANNEL

(71) Applicant: Nucleic Sensing Systems, LLC, Saint Paul, MN (US)

(72) Inventors: Cody Youngbull, Arlington, VA (US); Andrew Hatch, West Jordan, UT (US)

(21) Appl. No.: 18/500,421

(22) Filed: Nov. 2, 2023

Related U.S. Application Data
(60) Provisional application No. 63/422,153, filed on Nov. 3, 2022.

(51) Int. Cl. B01L 3/00

(52) U.S. Cl. CPC B01L 3/502746; B01L 2300/023; B01L 2300/0654

(57) ABSTRACT

Systems, methods, and apparatuses for the detection of changes within a fluid composition while it flows in a channel. Microfluidics devices can include a detector that may include a tunable offset mechanism. The detectors can work in conjunction with an energy source that passes energy through the flow channel and into the detectors.

### STATEMENT REGARDING FEDERALLY SPONSORED RESEARCH OR DEVELOPMENT

This invention was made with government support under NA21OAR0210295 awarded by National Oceanic and Atmospheric Administration. The government has certain rights in the invention.

This invention was made with government support under 2022-33530-37118 awarded by National Institute of Food and Agriculture. The government has certain rights in the invention.

### FIELD

This disclosure relates to fluidics differentiation systems, or more specifically, a detector within a microfluidics system that can include a flow channel where an energy source can transmit energy into the flow channel wherein the energy can then either pass through and then be acquired by a detector for analysis, or reflect back and then be acquired by a detector for analysis.

### BACKGROUND

Often, it is difficult in a microfluidic device to determine the properties of liquids flowing through a particular region of an instrument. Still, detecting certain events or ensuring the quality of a sample being processed can be critical. In the case of environmental monitoring, there is a need to ensure an appropriate sample of high quality is collected, one free of air, foam, mud, or foreign debris. Due to the nature of a sample flowing through a flow cell, it is necessary to use signal-boosting additives like fluorescent molecules, colorants, or the like. However, such signal-boosting additives can add cost and extra steps to an analysis. This invention seeks to eliminate such cost, and extra steps to provide a streamlined device and method for analyzing liquids.

### SUMMARY

According to this disclosure, a micro fluidics differentiation system can comprise a flow channel that may have a transparent tube with a generally round cross-section, wherein the flow channel can define a flow path. The micro fluidics differentiation system can also include a light source having an optical axis; an optical detector; and may have at least one optical fiber structured and configured to carry a light from the light source to the flow channel then on to the optical detector; the system may also include a data processing system that can be in communication with the optical detector and a microfluidics instrument, wherein the data processing system may also control functions of the microfluidics instrument in response to input from the optical detector.

In another embodiment, a fluidics differentiation system can comprise a flow channel that may have a transparent tube, wherein the flow channel can define a flow path. This embodiment may also have an energy source that can have a defined wavelength and a transmission axis; an energy-source detector; an energy source signal carrier that can be structured and configured to carry the defined wavelength from the energy source to the flow channel and then onto the energy-source detector; and may also include a data processing system that can be in communication with the energy-source detector and a microfluidics instrument, wherein the data processing system may control functions of the microfluidics instrument in response to input from the energy-source detector.

A method for controlling a microfluidics instrument can comprise the following steps: of providing a fluidics differentiation system that may comprise: a flow channel that can have a transparent tube, wherein the flow channel may define a flow path; a light source that can have an optical axis; an optical detector; an optical fiber that may be structured and configured to carry a light from the light source to the flow channel then onto the optical detector; and may include a data processing system in communication with the optical detector and a microfluidics instrument. The method may also include the following step of applying an algorithm within the data processing system to the signal from the optical detector to calculate a baseline for the signal; which may be followed by the step of monitoring the signal for a deviation from the baseline. Additional steps of the method may include communicating to the microfluidics instrument to control functions of the microfluidics instrument in response to the deviation of the optical signal to the baseline.

The Summary is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary as well as in the attached drawings and the Detailed Description, and no limitation as to the scope of the present invention is intended by either the inclusion or non-inclusion of elements, components, etc. in this Summary. Additional aspects of the present invention will become more readily apparent from the Detail Description, particularly when taken together with the drawings.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings.

FIG. 1 is a perspective view of an embodiment of a flow cell.

FIG. 2 is a cross-sectional view of the embodiment in FIG. 1.

FIG. 3 is an additional cross-sectional view of the embodiment in FIG. 1.

FIG. 4 is a wire-frame view of the embodiment in FIG. 1.

FIG. 5 is a wire-frame view of the embodiment in FIG. 3.

FIG. 6 is a cross-sectional view of another embodiment of a flow cell.

FIG. 7 is a wire-frame view of the embodiment in FIG. 6.

FIG. 7A is a partial view of the embodiment in FIG. 7.

FIG. 8 is a circuit diagram for an LED and phototransistor of an embodiment of a flow cell.

FIG. 9 is an exemplary oscilloscope scan for a signal difference between water and air.

FIG. 10 is an exemplary oscilloscope scan for a signal difference between oil and water.

### DETAILED DESCRIPTION

The present disclosure relates to methods and apparatuses for detecting changes in a fluid's composition within a flow channel, particularly to microfluidic flow cells that can be illuminated with a source of energy that falls on the electromagnetic spectrum. Various embodiments are described in detail with reference to the drawings, in which reference numerals may be used to represent parts and assemblies throughout the several views. References to various embodiments do not limit the scope of the systems and methods disclosed herein. Examples of construction, dimensions, and materials may be illustrated for the various elements; those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient. Still, these are intended to cover applications or embodiments without departing from the disclosure's spirit or scope. Also, it is to be understood that the phraseology and terminology used herein are for the purpose of description and should not be regarded as limiting.

Often, it can be difficult in a microfluidic device to determine the properties of liquids flowing through a particular region of the microfluidic instrument. Still, detecting certain events or ensuring the quality of a sample being processed can be critical. Examples where differentiating the properties of a fluid can come about when a working fluid, such as oil used to create partitions within an aqueous fluid, or the quality of a sample collection event may need to be determined to prevent contamination within the system that may lead to system failure.

The use of software and data processing algorithms can be employed to identify key thresholds and determine fluid type signatures to effectively differentiate between different qualities of water, oil, or air, as well as complex fluids like foam, mud, or large contaminants. A low-cost, simple-to-use sensor with software and data processing algorithms can be used to ensure high-quality sampling and provide feedback to a master controller to establish proper timing for processing a sample through the instrument. There is an inherent need to gain information about passing fluids or gases in microfluidics instrumentation. Precedent technologies are either too expensive or not sensitive enough for current needs. The proposed invention solves the need for a sensitive, inexpensive sensor that provides critical insight into the operation of microfluidic machines.

In cases of environmental monitoring, there is a need to ensure the collection of high-quality samples. Such samples are appropriately free of air, foam, mud, or any other foreign debris. An embodiment of a fluid-type sensor can enable processing by an instrument by basing the instrument's controls through the monitoring of the sensor and thus ensuring the proper fluid type is ready for downstream processing at an appropriate time and place.

The sensing mechanism within the fluid sensor can be tuned to detect the intrinsic properties of a fluid passing through it at an interrogation point. Additionally, the liquid can act as a lens to redirect a beam of energy, which in turn can affect the reception of the energy by a detector. In cases where debris such as mud or foam are sampled, the debris can act as a material that scatters or reflects energy, e.g., light, to elicit a dynamic response in the instrument from the communication from the fluid sensor.

A significant element of a fluid sensor can include the refractive index of the tubing within the sensor's housing, and how the refractive index of the tubing is relative to the refractive index of the sample being sensed within the tubing. Other important factors may include the wavelength and incidence angle of a light source, as well as the physical layout of the optical coupling. The incidence angle can range from 0° to 90°; where the light can be parallel to perpendicular with respect to the flow path. Water, air, and oil flowing through the tubing past an optical junction can be differentiated based on the baseline signal coming through to the sensor. Debris within the sample, such as foam and mud, can cause temporal and transmission changes to the light passing out of the tubing, which can also be differentiated by the detector based on characteristic signatures in the recorded signal.

The position of the tubing relative to the light beam being provided through the waveguide can help tune or detune the signal to be more or less sensitive to particular intrinsic fluid properties, such as the fluid's refractive index. This can enable the use of a single optical wavelength for all fluid types and may then not require the addition of any signal-boosting additives like fluorescent molecules, colorants, or the like.

Other lensing properties can include light polarization at the interface between the fluid and the tubing, phase shifts through the liquid or at the interface between the fluid and the tubing, or dynamic changes as the interface between two fluids inside the tubing flows through the optical junction.

To account for signal drift that may be caused by surface fouling, light source fluctuations, or biofilm growth within the sensor, a baseline referencing algorithm may be implemented to adjust the responses from the system. The signature for determining specific types of fluids may be derived from looking at changes over time and proper normalization and baseline establishment with known fluid types.

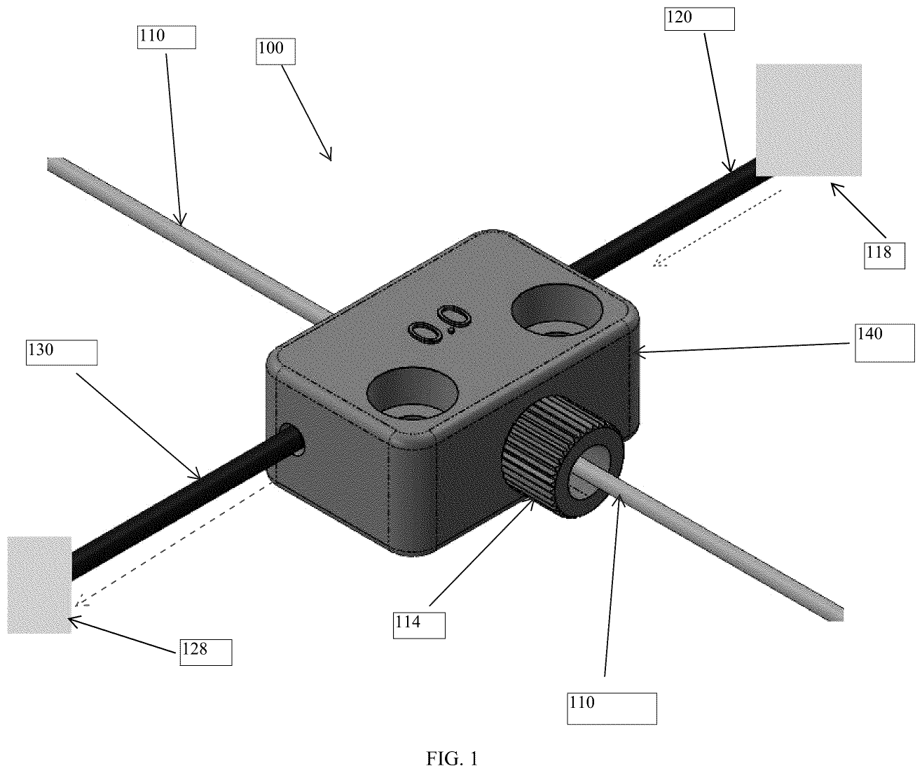

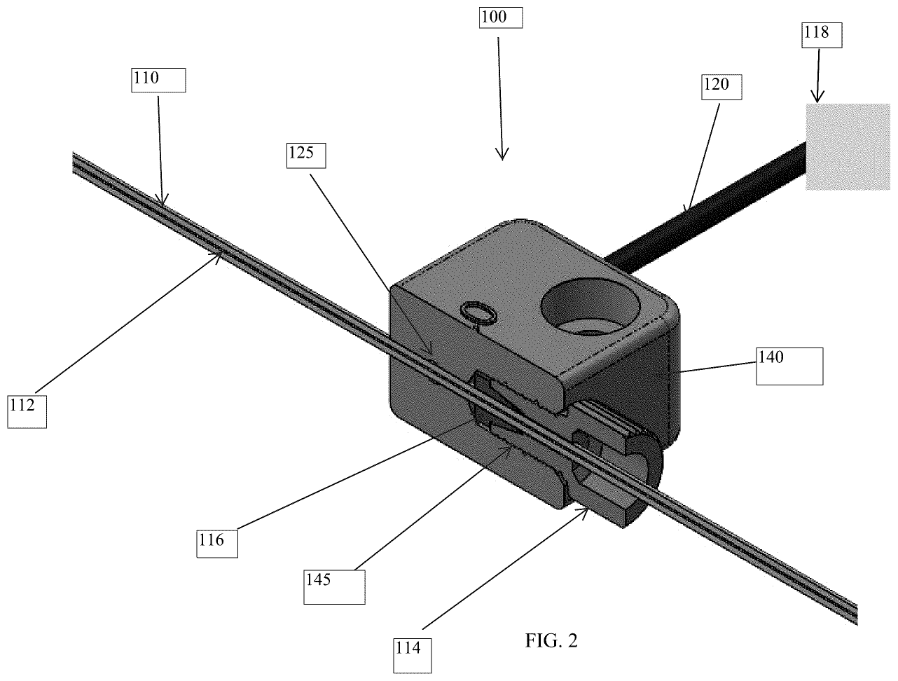

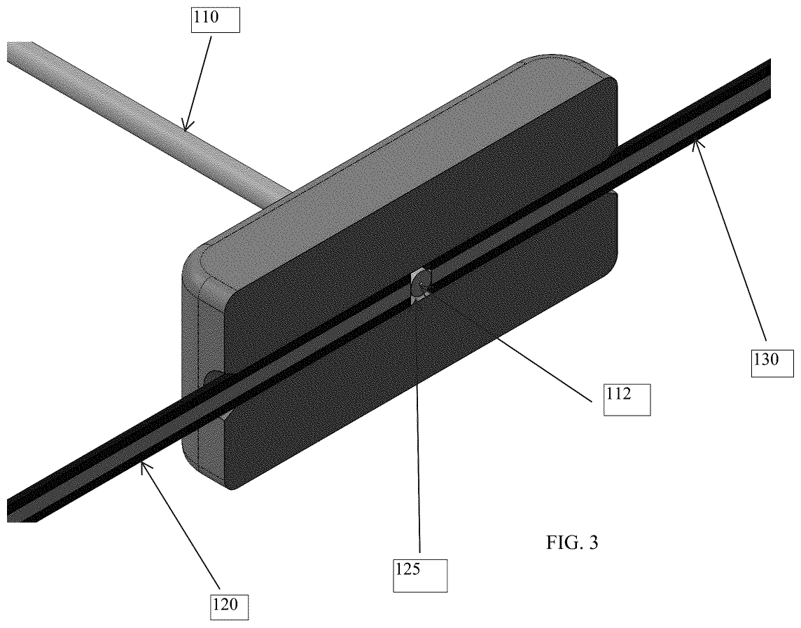

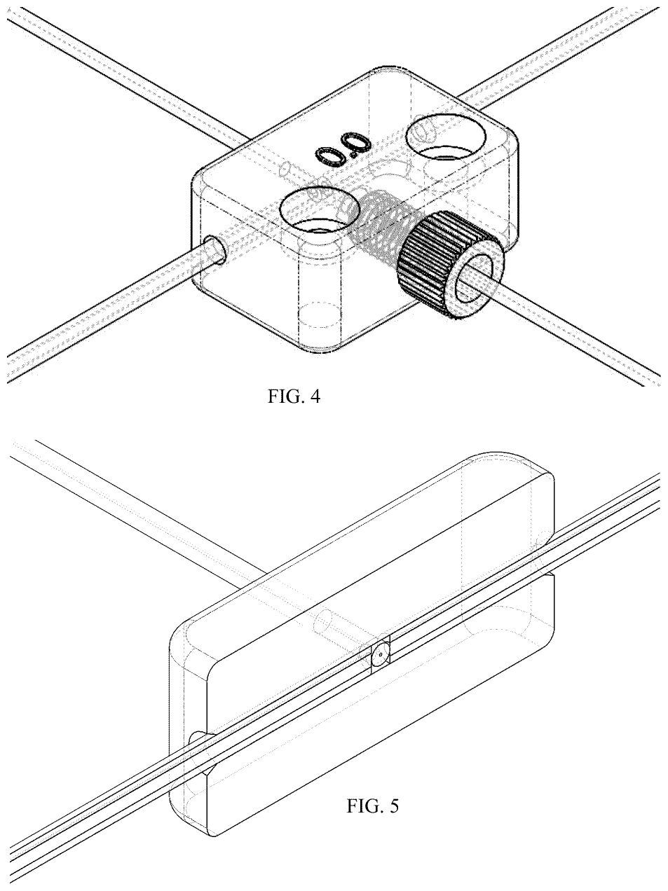

Regarding FIG. 1, fluids passing through a flow channel 110 can be illuminated with energy (electromagnetic or acoustic) transmitted through the sidewall of the flow channel. The flow channel 110 sidewall may be partially transparent to the illuminating energy. The illuminating energy may be collimated, diverged, or converged onto the flow channel 110 side wall. The source 118 may be disposed on one end of a first optical fiber 120. The illuminating energy may propagate through free space 125, directly impinging on the sidewall of the flow channel 110. The energy may also first pass through additional optical elements, including lenses, GRIN lenses, modulators, optical fibers, optical coupling- or index-of-refraction-matching materials, or liquids before impinging on the channel 110 sidewall. Changes in fluid composition, material phase, flow rates, and particle loading of the liquid inside the flow channel are monitored by observing changes in the intensity of the refracted, scattered, absorbed, and/or transmitted energy.

The energy that entirely exits the flow channel 110, after passing through the flow channel 110, which may be tubing, and the liquid therein, can similarly pass through coupling-liquids or index-of-refraction-matching liquids, lenses, gradient-index (GRIN) lenses, fibers, or other optical elements before ultimately being collected by a detector. The detector can measure the frequency, color, spatial intensity distribution, polarization, or phase information about the exiting energy.

In one embodiment of a flow-cell 100, the flow channel 110 is a polymer tube with a round cross-section having good transparency to blue light and having an appropriate refractive index. The illuminating energy may come from a light source 118 comprising blue light in this embodiment, can be delivered through a first optical fiber 120, and then transmitted, and scattered light can be collected through a second optical fiber 130. Disposed on an end of the second optical fiber 130 may be an optical detector 128. The exiting energy, in another embodiment, may be collected through the same optical fiber 120 that transmits an illuminating energy from the source 118 that may be combined with an optical detector, so long as there exists a way to differentiate the returning energy through the fiber, such as with a split fiber, beam splitter, or other inline filters. The flow path 110 in the flow channel may be offset, or angled relative to, the optical axis of the blue light source and blue light detector. The angle between the light source and the detector may also be off-axis. The offset distance of the flow path and angle of the light source and detector controls the relative amounts of fluid-scattered light and fluid-absorbed light sensed by the detector. In flow-cell 100, the offset can be fixed with a set distance of 0.0 microns; other contemplated embodiments may have different offsets. Included in the flow-cell 100 can be a flangeless nut 114 and a ferrule 116. The flangeless nut 114 and ferrule 116 may work together to secure the tube that can comprise the flow path 110. The ferrule 116 can be comprised of a flexible material that can include an inner diameter that may be slightly smaller than an outer diameter of the tube of flow path 100 to provide a friction fit. The flangeless nut 114 can include threading that can be engaged with additional threading in a cavity 145 of the housing 140 in the flow-cell 100 to secure the tube comprising the flow path 110.

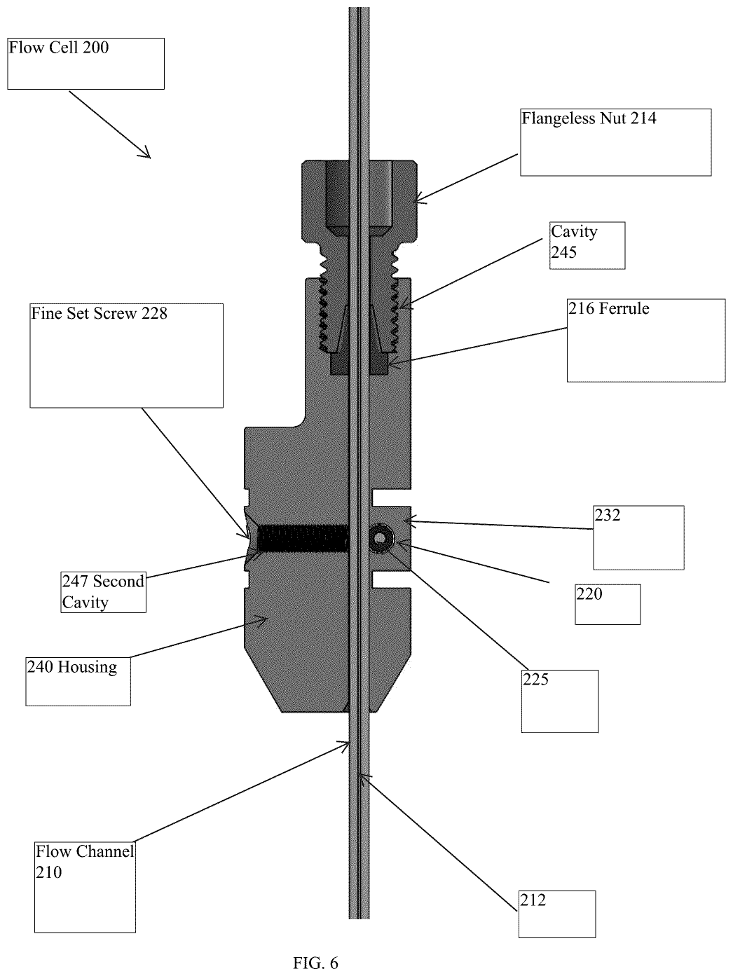

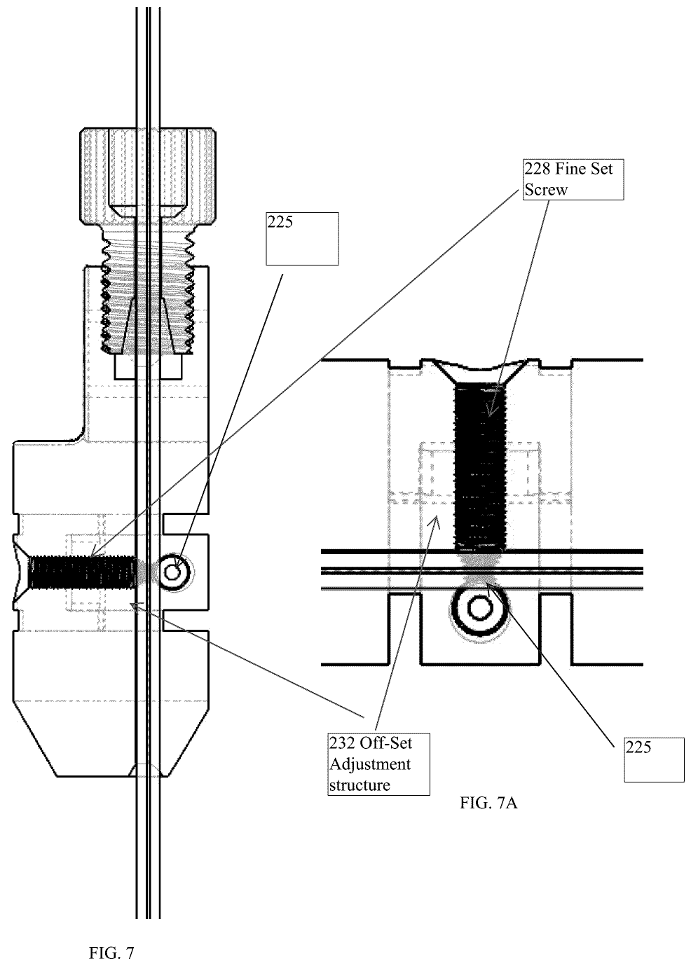

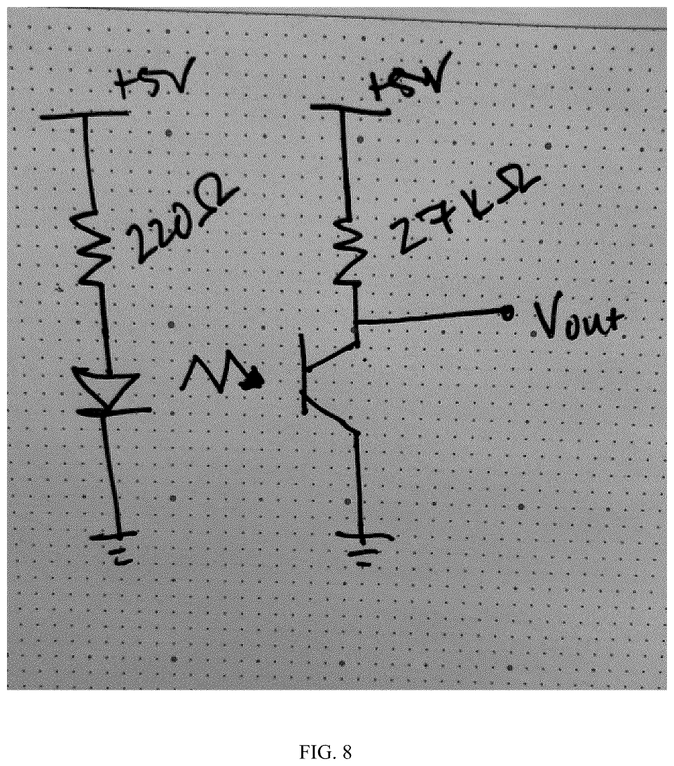

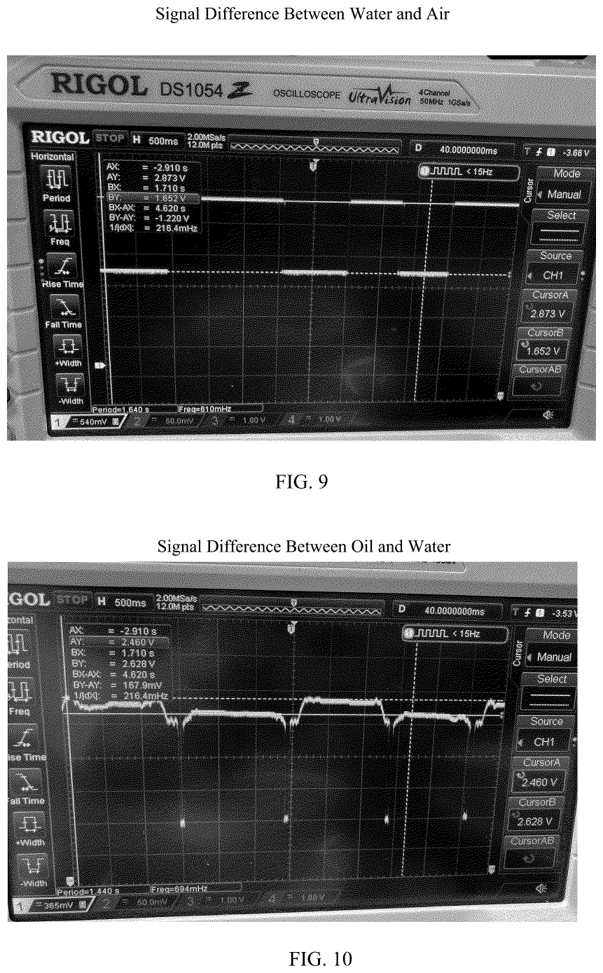

Regarding FIG. 6, an additional embodiment of a flow cell 200, where fluids that may pass through a flow channel 210 can be illuminated with energy (electromagnetic or acoustic) transmitted through the sidewall of the flow channel 210. The channel 210 may have a sidewall that can be partially transparent to the illuminating field. The illuminating energy may be collimated, diverged, or converged onto the side wall of the flow channel 210. The illuminating energy may propagate through free space, directly impinging on the sidewall, or it may first pass through additional optical elements, including lenses, GRIN lenses, modulators, optical fibers, optical-coupling materials, index-of-refraction-matching materials, coupling-liquids, or index-of-refraction-matching liquids before impinging on the sidewall of flow channel 210. Changes in fluid composition, material phase, flow rates, and particle loading of the liquid inside the flow channel are monitored by observing changes in the intensity of the refracted, scattered, absorbed, and/or transmitted energy.

In an embodiment of a flow cell 200, a flow channel 210 may be a polymer tube with a round cross-section and good transparency to blue light with an appropriate refractive index. The source (not shown in the cross-section) can comprise a blue light which can be delivered through a first optical fiber 220, and then transmitted and scattered light may be collected through a second optical fiber 230. In other embodiments of the flow cell 200, the exiting energy may also be collected through the same optical fiber 220 as the illuminating energy is transmitted, so long as there exists a way to differentiate the returning energy through the optical fiber 220, such as with a split fiber, beam splitter, or other inline filters. The flow path in the flow channel 210 may be offset or angled relative to the optical axis of the blue light source and blue light detector. The angle between the light source and the detector may also be off-axis. The offset distance of the flow path and angle of the light source and detector controls the relative amounts of fluid-scattered light and fluid-absorbed light that may be sensed by the detector.

Included in the flow cell 200, can be a flangeless nut 214 and a ferrule 216. The flangeless nut 214 and ferrule 216 may work together to secure the tube that comprises the flow path 210. The ferrule 216 may be comprised of a flexible material that can include an inner diameter that is slightly smaller than an outer diameter of the tube of flow path 210 to provide a friction fit. The flangeless nut 214 can include threading that can be engaged with additional threading in a cavity 245 of the housing 240 in the flow cell 200 that may secure the tube of flow path 210.

In an embodiment of a flow cell 200, an offset may be variable and can have a range of distance from 0 microns to the flow channel width. A fine set-screw 228 can be placed within a second cavity 247 within the housing 240. The fine set-screw 228, being adjustable on a single axis, can work in conjunction with an offset adjustment structure 232. Within the offset adjustment structure 232, there may be an optical junction 225. The optical junction 225 can be a portion of the first optical fiber 220 that directs energy from the energy source (not shown) into the flow path 210. The energy can either be reflected after passing through the flow channel 212, or the energy can pass entirely through the tube of flow path 210 and into a second optical fiber (not shown). In either case (either reflected or passed-through), the energy, after interacting with the contents of the flow path 210, can be directed to a detector (not shown). The detector can be comprised of numerous types of energy detectors. For the flow cell 200, either point detectors or array detectors may be used; such detectors can consist of a photodiode detector or a photodiode array detector. The offset adjustment structure 232 can move in accordance with the fine set screw 228. The movement of the offset adjustment structure 232 can change the offset distance of the optical junction 225 to fine-tune its position. Fine-tune adjustment can assist in optimizing a flow cell by having the ability to adjust the relative position of an optical junction in the final assembly to maximize signal response.

As the fluid index of refraction, fluid composition, material phase, or particulate concentration changes in the fluid, the light intensity, frequency, wavelength, spatial intensity distribution, or phase distribution can change on the detector. This change can be quantified to measure the material properties inside the flow channel. The energy source may be a light source which can be incoherent or coherent. The detector may be a point detector or a detector array. The detector array can more easily distinguish between scattering and absorption by the intervening fluid. Methods of using the detector may not require a monitored fluid to be actively responsive to the energy. The scattering of the illuminating energy can be elastic or inelastic.

In any of the embodiments of the flow cell, the method to process the data should take into account that signals received by a point detector are fundamentally temporal information. Such a signal can vary by intensity, frequency, wavelength, phase, or polarization versus time. Additionally, in embodiments with an array detector, the signal received by an array detector can include spatial variations in addition to temporal changes. The nominal intensity of a received signal versus time can be referred to as a signal baseline. The following steps may occur when processing the data from the detector. First, determining the automatic signal baseline identification so as to avoid any issue which may be associated with the light source intensity fluctuations. Second, determine any change in intensity to be able to correlate a response to a particular fluid. Third, determine any changes in the spatial distribution of the aforementioned energy properties, which can be used to correlate to a particular fluid and a particular fluid's properties.

The refractive index may affect or be affected by any of the following elements of the flow-cell system: (1) intrinsic fluid property (index of refraction); (2) temperature; (3) mating interface, which can drive the polymer selection for the tubes used in the flow cell; (4) the wavelength of light (LED and detector), which can include (a) the optical wavelength to maximize scattering or absorption (e.g., IR has a poor response, optimize for absorption bands of water and/or polymer), or (b) multiple wavelengths can be used simultaneously to fingerprint the response; (5) the fluid composition, which can vary by (a) particulates causing physical obstructions, (b) complex emulsion (foam or oil), (c) the chemistry, (d) cells (aquatic life); (6) surface fouling of the flow channel, which can be robust to a certain extent, or a signal that the flow cell requires servicing of the instrument; (7) the spatial configuration of the tubing in a flow cell which can depend on the tubing selection, relative position of the energy source, and detector calibration, which may be affected by (a) cross-section, (b) diameter, (c) angle between the emitter and detector, and (d) offset of tubing; (8) two in a line, (a) leaks, (b) flow rate, (c) response timing, and (d) course vs. fine sensitivity.

Considerations for the flow channel may include the following factors: (1) transparency of a material at a desired optical wavelength; (2) the tuning of the refractive index relative to the fluid of greatest interest (e.g., closer to water rather than air or oil); (3) the smoothness of the inner surface for impacts on fluid flow, fouling, shear, and scatter; (4) cross-sectional dimensions; and (5) thickness of the tube being measured from the outer diameter to the inner diameter.

However, drift in the baseline can be considered noise, which may impact the ability to distinguish different fluid signatures properly. Therefore, it may be required to embody methods to distinguish different fluids to initiate a system response and reduce the impacts from a baseline shift that would otherwise confound the appropriate response, e.g., delayed response or incorrect response. A pulsed light source may improve signal amplification, as can the use of different simultaneous wavelengths.

Methods to utilize the flow cell with a detector can include a response by the sensor to control other instrument functions. For example, when a sensor detects a change in a fluid's composition, a valve or pump may be activated or deactivated to control a response.

Fluids and gasses like water, air, and oil are typically clear and transparent, so purely looking at them by eye or through a camera, they cannot be a readily apparent method of differentiation. However, they all have different intrinsic properties of refraction, so focusing the detection on the refraction of the fluid within a tube can differentiate between otherwise impossible-to-detect optical differences. For example, a polymer can have a refractive index around 1.3, glass can have a refractive index around 1.5, and air can have a refractive index around 1.0. Other envisioned materials known to the art could have a refractive index of around 2.0.

Furthermore, by tuning position, the refractive index of materials, and incorporating time-domain changes when exchanging between one fluid to the next, a quality score can readily be provided that the fluid is what is desired. Differentiating between these intrinsic properties can only be accomplished by establishing a proper baseline and accounting for drift in signal intensity as the energy source can fluctuate over time, or surfaces and materials can age and foul with proteins, contaminants, biofilms, or other such fouling agents.

### REFERENCE TAGS

100—Flow Cell
110—Flow Path (tube)
112—Inner flow path
114—Flangeless Nut
116—Ferrule
118—Energy Source
120—Optical Fiber with Energy Path from Source
125—Optical Junction
128—Detector
130—Optical Fiber with Energy Path to Detector
132—Offset Adjustment Structure
140—Housing
145—Cavity
150—Optical Coupling
200—Flow Cell
210—Flow Path (tube)
212—Inner flow path
214—Flangeless Nut
216—Ferrule
220—Optical Fiber with Energy Path from Source
225—Optical Junction
228—Fine Set Screw
230—Optical Fiber with Energy Path to Detector
232—Offset Adjustment Structure
240—Housing
245—First Cavity
247—Second Cavity
250—Optical Coupling

Persons of ordinary skill in arts relevant to this disclosure and subject matter hereof will recognize those embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is also intended to include features of a claim in any other independent claim, even if this claim is not directly made dependent on the independent claim.

We claim:

1. A fluidics differentiation system comprising:
a flow channel having a transparent tube with a generally round cross-section, wherein the flow channel defines a flow path;
a light source having an optical axis;
an optical detector;
at least one optical fiber structured and configured to carry a light from the light source to the flow channel then on to the optical detector; and
a data processing system in communication with the optical detector and a microfluidics instrument, wherein the data processing system can control functions of the microfluidics instrument in response to input from the optical detector.

2. The fluidics differentiation system of claim 1, wherein the light source transmits blue light.

3. The fluidics differentiation system of claim 1, further comprising an offset adjustment structure.

4. The fluidics differentiation system of claim 3, wherein the flow path and the optical axis are offset at an angle ranging from zero degrees to ninety degrees.

5. The fluidics differentiation system of claim 1, further comprising an inline filter disposed on the at least one optical fiber.

6. The fluidics differentiation system of claim 1, wherein the at least one optical fiber comprises two optical fibers, wherein a first optical fiber carries the light to the flow channel and a second optical fiber carries the light from the flow channel to the optical detector.

7. The fluidics differentiation system of claim 1, wherein the optical detector can be one of a point detector and an array detector.

8. The fluidics differentiation system of claim 3, wherein the transparent tube has a refractive index ranging from 1.0 to 2.0.

9. The fluidics differentiation system of claim 1, wherein the light has a wavelength ranging from 400 nm to 495 nm, and the optical axis is at an incidence angle ranging from zero degrees to ninety degrees with respect to the flow path.

10. A fluidics differentiation system comprising:
a flow channel having a transparent tube, wherein the flow channel defines a flow path;
at least one energy source having a defined wavelength and a transmission axis;
an energy-source detector;
at least one energy source signal carrier structured and configured to carry the defined wavelength from the energy source to the flow channel and then onto the energy-source detector; and
a data processing system in communication with the energy-source detector and a microfluidics instrument, wherein the data processing system can control functions of the microfluidics instrument in response to input from the energy-source detector.

11. A method of controlling a microfluidics instrument comprising the following steps:
providing a fluidics differentiation system comprising:
a flow channel having a transparent tube, wherein the flow channel defines a flow path;
a light source having an optical axis;
an optical detector;
at least one optical fiber structured and configured to carry a light from the light source to the flow channel then onto the optical detector; and
a data processing system in communication with the optical detector and a microfluidics instrument;
applying an algorithm within the data processing system to the signal from the optical detector to calculate a baseline for the signal;
monitoring the signal for a deviation from the baseline; and
communicating to the microfluidics instrument to control functions of the microfluidics instrument in response to the deviation of the optical signal to the baseline.
